(19) United States
(12) Patent Application Publication
(10) Pub. No.: US 2015/0287304 A1
(43) Pub. Date: Oct. 8, 2015

(54) Identification Capturing Security Gate

(71) Applicant: Thomas E. Valiulis, Rockford, IL (US)

(72) Inventor: Thomas E. Valiulis, Rockford, IL (US)

(73) Assignee: Southern Imperial, Inc., Rockford, IL (US)

(21) Appl. No.: 14/246,187

(22) Filed: Apr. 7, 2014

(51) Int. Cl. G08B 13/24

(52) U.S. Cl. CPC G08B 13/2405; G08B 13/2471

(57) ABSTRACT

A security system is provided that is comprised of an electronic article surveillance assembly (EAS), a cellular phone identification assembly communicatively coupled to the electronic surveillance assembly, a computer communicatively coupled to the assemblies. The assemblies define a security zone. Upon detection of a tagged item of retail merchandise by the EAS, the cellular phone identification assembly captures an at least one unique cellular phone identifier for storage within a storage device of the computer.

### FIELD OF THE INVENTION

This invention generally relates to retail store security systems.

### BACKGROUND OF THE INVENTION

To deter retail theft and catch shoplifters, retail stores frequently employ electronic article surveillance (EAS) assemblies at strategic locations such as their exit doors. An example of such an EAS assembly is described in U.S. Pat. No. 5,387,900 the entire teachings of which are incorporated herein by reference. EAS assemblies may create an interrogation zone also known as security zones into which the EAS may transmit a signal that saturates the security zone. Items of retail merchandise are given tags which are passively or actively detectable as they pass through the EAS security zone. EAS systems utilize, for example, radio frequency identification (RFID) tags, radio frequency (RF) tags, acoustic magnetic (AM) tags and even microwave tags. These tags are removed or deactivated at the time of purchase. Thus, in general, the tags remain only on stolen items of retail merchandise. As the tagged item of retail merchandise passes through the interrogation zone of the EAS, it is detected and an alarm is triggered that notifies store personnel of the theft.

Retail merchants generally instruct store personnel not to endanger themselves by chasing the thief. They are typically instructed to notify and wait for security personnel or the police to respond. Often times the thief is able to escape from the store into an awaiting vehicle without further pursuit. Store personnel are left to review video surveillance, if there has been any taken, and or to give a verbal description of the thief to the police. Unfortunately, at times the video or oral description or both are simply not clear. Even if they are clear, it remains difficult to locate an unnamed thief and correlate identification based on imperfect video or a deficient oral description of the thief's person. Thus, the thief's personal identification can elude retailers and security and make prosecution for the theft difficult if not impossible.

Security systems that are much more regional and even global in scope are also known that utilize the transmission and unique identifiers of cellular phones. Such systems and methods are described for example in U.S. Patent Publication No. 2011/0134240, the entire teachings of which are incorporated herein by reference. In such systems passive and active detection of unique cellular phone identifiers are collected to identify, track, and locate cell phone users. Unfortunately, these systems are costly and intended for large law enforcement agencies in a post 9-11 terrorism environment. Such systems are impractical for a retail merchant.

Accordingly, there is a need for a low cost but effective security system for retail merchants that is able to assist in identification of a retail thief for later apprehension and eventual prosecution.

The invention provides such a security system. These and other advantages of the invention, as well as additional inventive features, will be apparent from the description of the invention provided herein.

### BRIEF SUMMARY OF THE INVENTION

In one aspect, the invention provides a security system that includes an electronic article surveillance assembly (EAS). A cellular phone identification assembly is communicatively coupled to the electronic surveillance assembly. A computer is communicatively coupled to the assemblies. The assemblies define a security zone. Upon detection of a tagged item of retail merchandise by the EAS, the cellular phone identification assembly captures an at least one unique cellular phone identifier for storage within a storage device of the computer.

The EAS is at least one of a radio frequency (RF) system, a radio frequency identification system (RFID), or an acoustic magnetic (AM) system. The EAS may further include a transmitter in an antenna frame that is in opposed space relation to a receiver in a second antennae frame of the EAS. The cellular phone identification assembly may be a stand-alone assembly or may be located within one of the first or second antennae frames.

In yet other embodiments the EAS may include a transmitter and receiver in a same antenna frame and the cellular phone identification assembly may be either a stand-alone assembly or may be located within the same antenna frame.

In certain embodiments the cellular phone identification assembly may include at least one stand-alone transceiver for active and passive detection of the at least one unique cellular phone identifier.

The captured at least one unique cellular phone identifier may be one of a Bluetooth identifier, a WiFi media access control (MAC) address, a Near Field Communication (NFC) identifier, and a Wireless Communication Network (WCN) identifier.

In certain embodiments a video surveillance system may be communicatively coupled to the assemblies and the computer.

Another aspect of the present invention is directed towards a method of capturing a unique cellular phone identifier of a suspected retail thief. The method includes detecting a tagged item of retail merchandise carried by the suspected retail thief within the security zone. The detection is communicated to a cellular phone identification assembly located within the security zone and to an alarm system. An at least one unique identifier of a cellular phone of the suspected retail thief is captured by the cellular phone identification assembly. A computer stores for later retrieval and analysis a detection time, the at least one unique cellular phone identifier and a capture time of the at least one unique cellular phone identifier. The security zone is provided by an electronic article surveillance assembly (EAS) and a cellular phone identification assembly communicatively coupled to the EAS.

The EAS may be one of at least a radio frequency (RF) system, a radio frequency identification system (RFID), or an acoustic magnetic (AM) system. In certain embodiments the cellular phone identification assembly is comprised of a transceiver and a receiver. The security zone may be located both inside and outside of a retail store.

The step of providing the security zone include may further include installing and communicatively coupling the cellular phone identification assembly in a pre-existing EAS within a retail store. In yet other embodiments the step of providing the security zone may include providing a stand-alone cellular phone identification assembly that is communicatively coupled to a pre-existing EAS within a retail store. The capturing of the at least one unique identifier may be one of at least a Bluetooth identifier, a WiFi media access control (MAC) address, a Near Field Communication (NFC) identifier, and a Wireless Communication Network (WCN) identifier.

The method may further include the step of notifying a jurisdictional law enforcement agency and retrieving from the computer storage, the transmission time, the at least one unique cellular phone identifier and the capture time of the at least one unique cellular phone identifier.

In yet another aspect of the present invention a method for capturing a unique cellular phone identifier of a retail thief is provided. The method includes providing a security zone. The security zone includes an electronic article surveillance assembly (EAS) and a cellular phone identification assembly that is communicatively coupled to the assemblies and to a computer. A transmission is detected from a tagged item of retail merchandise by the EAS as the retail merchandise passes through the security zone. A notification of the detection is communicated to the computer and to the cellular phone identification assembly. An at least one of a unique cellular phone identifier is captured by the cellular phone identification assembly. The capture of the at least one unique cellular phone identifier is communicated to the computer for storage. The computer stores for later retrieval a detection time, the at least one unique cellular phone identifier and a time of capture of the at least one of a unique cellular phone identifier. The method may include the additional step of communicating the detection time, the at least one unique cellular phone identifier and the time of capture to law enforcement personnel.

In yet another aspect prior to the step of communicating a notification of the transmission to the computer, the notification is sent to a controller for further notification to the cellular phone identification assembly.

Notification to the cellular phone identification assembly may trigger the cellular phone identification assembly to capture the at least one unique cellular phone identifier. The method may provide that the cellular phone identification assembly is located inside a retail store and outside the retail store. The cellular phone identification assembly may be comprised of at least one transceiver. The EAS may be at least one of a radio frequency (RF) system, a radio frequency identification system (RFID), or an acoustic magnetic (AM) system. The at least at least one unique identifier may be one of a Bluetooth identifier, a WiFi media access control (MAC) address, a Near Field Communication (NFC) identifier, and a Wireless Communication Network (WCN) identifier.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic view of an embodiment of a security system of the present invention;

FIG. 2 illustrates an embodiment of a single antenna frame comprising an EAS system incorporating an embodiment of a cellular phone identification assembly;

FIG. 3 illustrates an embodiment of a single antenna frame comprising an EAS system communicatively coupled to a stand-alone cellular phone identification assembly;

FIG. 4 illustrates another embodiment of the present invention using two antenna frames and incorporating an embodiment of a cellular phone identification assembly; and

FIG. 5 is a block diagram of an embodiment of a method or capturing a unique cellular phone identifier of a retail thief.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

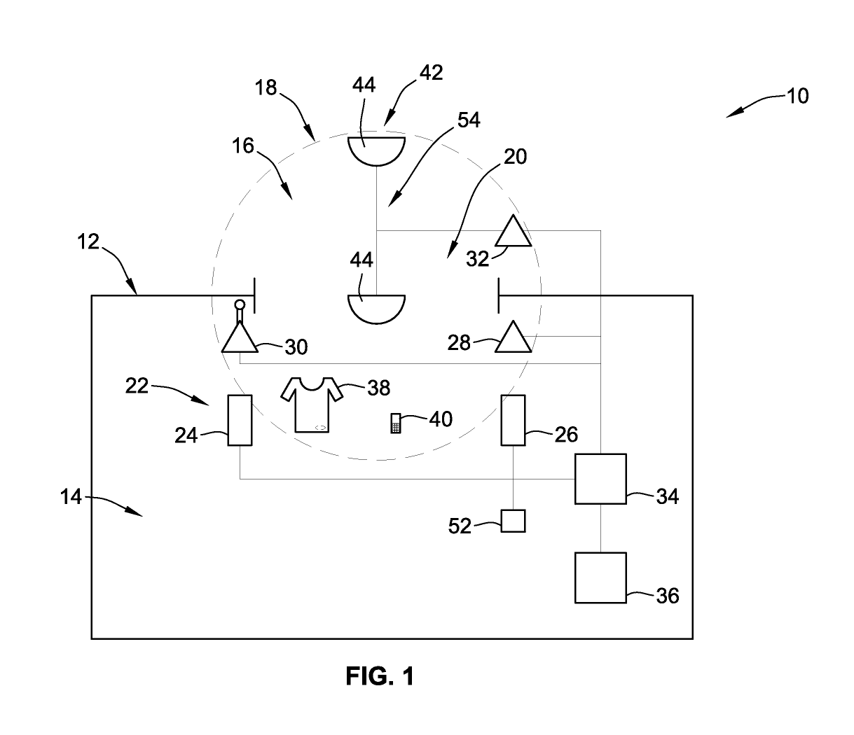

Turning now to the drawings and with reference to FIG. 1, a schematic illustration of an embodiment of a security system 10 of the present invention is illustrated. The security system 10 includes an electronic article surveillance assembly (EAS) 22. A cellular phone identification assembly (CPIA) 28 is communicatively coupled 48 to the EAS 22. A computer 36 is communicatively coupled 48 to the assemblies 22, 28. The assemblies 22, 28 define a security zone 18. Upon detection of a tagged item of retail merchandise 38 by the EAS 22, the CPIA 28 captures an at least one unique cellular phone identifier for storage within a storage device of the computer 36.

FIG. 1 depicts a schematic illustration of an embodiment of the security system 10. Many retail stores may already have an EAS assembly present. Accordingly, the retail stores may utilize a retro fit of an embodiment of the security system 10 that incorporates the pre-existing EAS 22 or may prefer to have an embodiment of security system 10 installed in its entirety. The embodiment of FIG. 1 illustrates an EAS assembly 22 that is comprised of two antenna frame members 24, 26. Antenna frame member 24 is a transmitter while antenna frame 26 is a receiver. The EAS 22 creates a security zone 18 between the two antenna frame members 24 and 26 inside the retail store 12 near the exit 20. As a thief moves to the exit 20 he passes between the two antenna frame members 24, 26 with a tagged item of retail merchandise 38. The tagged item of retail merchandise 38 is detected by the EAS 22 assembly. It can be readily appreciated that the type of detection depends upon which EAS 22 assembly is present. The EAS 22 assembly may be one of a radio frequency (RF) system, a radio frequency identification system (RFID), or an acoustic magnetic (AM) system.

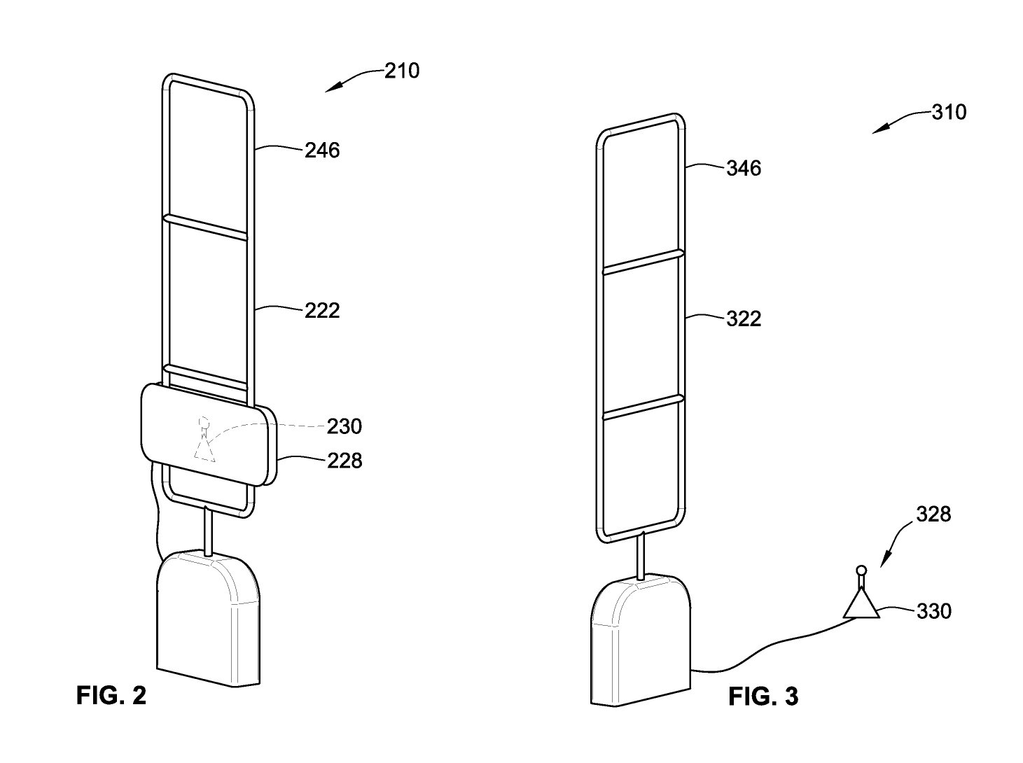

It may be that where a store has a pre-existing EAS 22 in place, it may be one utilizing a single antenna frame 46 that includes both the EAS 22 transmitter and receiver for detection of the tagged item of retail merchandise 38. (See for example FIGS. 2 and 3). As will be further discussed below, security system 10 may be installed so as to incorporate the store's 12 pre-existing single antenna frame 46. Further, where the retail store 12 does not have a pre-existing EAS 22, security system 10 may be installed utilizing only the single antenna embodiment 46.

Upon detection by the EAS 22 of a tagged item of retail merchandise 38, notification of the detection, in an embodiment, may be sent to an alarm 52. The alarm 52 may be one of any number of alarm types known, for example, a light readily seen by store personnel on one or both of the antenna frame members 24, 26. In yet other embodiment the alarm 52 may be a light in combination with an audible alarm.

In certain embodiments, as shown here for example, the EAS 22 may be communicatively coupled 48 to a controller 34 that transmits the detection as a signal to the alarm 52 and then to computer 36 for processing the signal so as to alert store employees and/or security personnel within the store 12 via a computer network within the store, that is each check out screen (not shown) may show the alarm of a retail theft is in progress. The computer 36 stores the time of the detection for later retrieval and coordination with a capture time of a unique cellular phone identifier. Further, in certain embodiments the EAS 22 sends notification of the detection directly to the CPIA 28 in addition to the computer 36.

In the embodiment of FIG. 1 both antenna frames 24 and 26 of the EAS 22 are communicatively coupled 48 to a controller 34. Controller 34 is operable to signal the alarm 52. Additionally, the controller 34 transmits the detection by the EAS 22 to computer 36. Controller 34 then is operable to receive and transmit signals from the EAS 22, the CPIA 28, the computer 36, the alarm 52 and as will be discussed a video surveillance system 42.

Some retail stores 12 may have pre-existing video surveillance systems 42. In an embodiment, security system 10 may be communicatively coupled to the video surveillance system 42. Further, the controller 34 may be utilized in certain embodiments to send a notification signal to the video surveillance system 42 to begin (if not already doing so) to begin to record video and to send the video to computer 36 for storage and later retrieval. Thus, for example, as shown here, video surveillance system 42 has omni directional cameras 44. Upon detection of a tagged item of retail merchandise 38 by the EAS 22, the EAS sends a notification signal of the detection to controller 34. Controller 34 signals the video surveillance system 42 to both begin recording and to store the video for later retrieval in computer 36.

Still with reference to FIG. 1, security system 10 includes, a cellular phone identification assembly (CPIA) 28 communicatively coupled 48 to EAS 22. A retail thief carrying a cellular phone (cell phone) 40 can be identified by certain ones of the phone's 40 transmissions. For example, as illustrated in FIG. 1 the thief is carrying a cell phone 40 as he passes through security zone 18. The thief's unique cell phone identifier is captured by the CPIA 28 as he passes through the security zone 18. By unique cellular phone identifiers it is meant that no two cellular phones will transmit all of the exact same signals. Some of each cell phone's transmission unique in relation to any other cell phone. Such unique identifiers are the electronic equivalent of social security numbers. They are unique, one of a kind, identifiers for a cell phone. Thus, when the thief is apprehended his cellular phone can be identified. The unique cellular phone identifier then is one more tool that can be used to correlate the thief to the scene of the crime together with video, verbal description, and the stolen item of retail merchandise.

More specifically, one or more of the unique cellular phone identifiers may be the associated the cell phone's 40 use of wireless communication networks (WCN). The cell phone 40 in communicating within the WCN utilizes unique identifiers. These WCN identifiers may be the cell phone's telephone number, the electronic serial number (ESN), the MIN (mobile identification number), the international mobile equipment identifier (IMEI). The list is not exhaustive. Those skilled in the art will recognize that there are other unique cellular phone identifiers for any given cell phone, and all such unique cellular phone identifiers are encompassed herein. These standardized identifiers are available over the radio signaling interface between the mobile phone 40 and the wireless communication network. Thus, at times the cellular phone 40 when passing into the security zone 18 might very well be actively communicating with the WCN. Such communication and in particular the unique cellular phone identifiers associated with the cell phone's use of the WCN are captured by the CPIA 28 when notified to do so by the EAS 22 after the EAS 22 has detected a tagged item of retail merchandise 38 passing through the security zone 18. Such WCN detections of WCN identifiers are possible at ranges of up to 50 meters.

Cellular phones 40 also utilize short range communications systems such as WiFi and Bluetooth and Near Field Communications (NFC). Thus, unique identifiers, in addition to those associated with WCN transmissions, may also be obtained in certain embodiments of security system 10 from one or more WiFi, Bluetooth or NFC transmissions from the cell phone passing through security zone 18.

Each cell phone 40 that has Bluetooth capability has a unique Bluetooth identifier. Each cell phone that has WiFi capability has a WiFi network interface that typically provides the cellular phones media access control (MAC) address. The MAC address is unique to each cellular phone's wireless network interface controller. Further each cell phone 40 that has NFC capability has a unique NFC identifier.

The cell phone's 40 unique cellular identifier associated with Bluetooth may be detectable up to 100 meters from the receiver 31. WiFi may be detectable up to 100 meters, while Near Field transmissions may be detectable at 5 meters.

In the embodiment of FIG. 1, the CPIA 28 is a stand-alone assembly. By stand-alone it is meant that the components of the CPIA 28 are not embedded in or physically supported by the structures of the EAS. The sole connection between the EAS 22 and the CPIA 28 is the communicative coupling 48 between the two assemblies 22, 28. The communicative coupling 48 in this embodiment is shown by traditional wiring but as can be readily appreciated other connection means are possible for example via WiFi.

The CPIA 28 is composed of a transceiver 30 and two receivers 31, 32. Receiver 31 is located inside 14 retail store 12 and receiver 32 located outside 16 retail store 12. The CPIA 28 is placed downstream 54 of the EAS 22. The EAS 22 is communicatively coupled to the CPIA 28. Both assemblies 22, 28 are communicatively coupled to the computer 36. As previously discussed, such communicative coupling may include a controller 34.

When a tagged item of retail merchandise 38 passes through the security zone 18 it is detected by the EAS 22. The EAS 22 sends a notification signal either through controller 34 or directly to the CPIA 28. Transceiver 30 and receivers 31, 32 of the CPIA 28 are triggered to actively, in the case of transceiver 30, or passively, in the case of receivers 31, 32 to capture one of the unique identifiers of a cellular phone 40 passing through the security zone 18.

Thus, cellular phones utilizing a WCN or engaged in Bluetooth, WiFi and/or NFC or actively queried to engage in such transmissions by transceiver 30, transmit signals that are unique cellular phone identifiers that can be captured by the CPIA 28 assembly. Once the unique identifier is captured it is transmitted to the computer 36 for storage and later retrieval. Thus, at this point, the computer 36 has stored the EAS 22 detection time, the unique cellular phone identifier and the time of capture of the unique cellular phone identifier.

In a preferred embodiment the transceiver seeks to obtain the WiFi unique identifiers. The WiFi identifier is preferred because processing times associated with WiFi are much faster than the slower communications of Bluetooth and NFC.

FIG. 1 illustrates an embodiment that seeks to make the security zone as large as possible downstream 54 of the EAS 22 by placing receivers 31 outside 16 of retail store 12. In yet other embodiments transceivers 30 may be outside 14 as well. It can be readily appreciated that by expanding the security zone 18 outside 16 of the retail store 16 the CPIA 28 has more time to capture one or more of the unique identifiers of cell phone 40. Receivers 31, 32 may be embedded in the retail store external wall itself, a sidewalk outside of the store or even for example near structural objects within the retail store's parking lots, for example near light fixtures.

In certain embodiments the CPIA 28 is passive only. Accordingly, only a passive receiver or receivers 30, 31 are utilized. The receivers 30, 31 are triggered 30, 31 by the EAS 22 either directly or via the controller 34 or computer 36 to capture a short range communication of the unique cellular phone identifier from one of or a combination of WiFi, Bluetooth, or NFC from the cell phone 40.

Also depicted in FIG. 1 is a preexisting video surveillance system 42 comprised of at least one omni directional camera 44. These video surveillance systems 42 may be in continuous use, that is, they are constantly recording and storing digital video. Other video surveillance systems 42 may only record video when directed to do so. Security system 10 can incorporate most of these pre-existing video surveillance systems 42. Video surveillance system 42 can be communicatively coupled to the EAS 22 directly or via controller 34 or computer 36 so that when the EAS 22 detects a tagged item of retail merchandise 38, a notification signal is sent by the EAS 22 to video surveillance system 42 to trigger video capture of the retail thief as he passes through the security zone 18. The digital video is transmitted and stored in computer 36 for later retrieval.

As depicted in FIG. 1 as the retail thief passes through the security zone 18 the EAS 22 detects the tagged item of retail merchandise 38. Upon detection of the tagged item of retail merchandise 38 the EAS 22 sends notification of the detection to alarm 52 so as to notify employees of the store and/or the store's 12 own security personnel. Further, the notification of the detection is simultaneously sent to the CPIA 28 to trigger capture of at least one unique cellular phone identifiers. In this embodiment, detection is both active through the transceiver 30 and passive through receivers 31 and 32 both internal 14 and external 16 to the retail store 12. Further the security system 10 is coupled to a video surveillance system 42. The detection by the EAS 22 triggers the video surveillance system 42 to capture video of the thief and to transmit the digital images for storage in the computer 36. Furthermore, the EAS 22 on detection of the tagged item of retail merchandise 38 triggers computer 36 to record the detection time.

Meanwhile, in light of the alarm 52, store personnel typically will have time to obtain their own visual identification of the thief and to contact law enforcement for apprehension. Where the thief has made an escape and has left the store 12 and its vicinity, for example via car, law enforcement personnel upon arrival at the store 12, may retrieve with the help of store personnel from the computer 36 a transmission time, the unique cellular phone identifier, and the digital video surveillance.

Correlation between the transmission time, the unique cellular phone identifier and the video is then made. It would not be uncommon that the CPIA 28 has captured more than one unique identifier because of the large security zone 18. However, between the video, timing, and verbal description of the thief the unique identifier can be narrowed down to a few if not sole suspect.

Turning now to FIGS. 2-5, alternative embodiments of the security system 10 of FIG. 1 are illustrated. The alternative embodiments 210, 310 and 410 are similar to security system 10 and the foregoing descriptions with respect to FIG. 1 are applicable to the alternative embodiments with only the differences discussed herein.

In FIG. 2, the EAS 222 is comprised of a single antenna frame 246. As with FIG. 1, this embodiment may involve a preexisting EAS 222. Where the EAS 222 is pre-existing the security system 210 is installed to incorporate the pre-existing EAS 222. As shown here, the CPIA 228 is built into the pre-existing single antenna frame 246 of the EAS 222. The transceiver and receiver of the EAS 222 are co-located within the single frame member 246. Unlike the embodiment of FIG. 1, here the CPIA 228 is installed into antenna frame 246. That is, the CPIA 228 in this embodiment is not free-standing. The CPIA 228 may be comprised of only a transceiver 230 or only a receiver communicatively coupled to EAS 222. FIG. 2. is an embodiment that is entirely located inside of a retail store 112. However, the security zone may extend outside the retail store because active or passive reception of a unique cellular phone identifiers are possible from outside the retail store.

FIG. 3 depicts the CPIA 328 as a stand-alone assembly. In this embodiment the EAS 322 is comprised of a single antenna frame 346 that includes the EAS 322 transmitter and receiver communicatively coupled to a transceiver 30 of the CPIA 328 stand-alone assembly. In yet other embodiments, the CPIA 328 stand-alone assembly may be comprised of only a receiver 331 communicatively coupled to EAS 322 for detection of the unique cellular phone identifier or may be comprised of multiple transceivers 330 and receivers 331. Further, in this embodiment the security system 310 may extend outside a retail store.

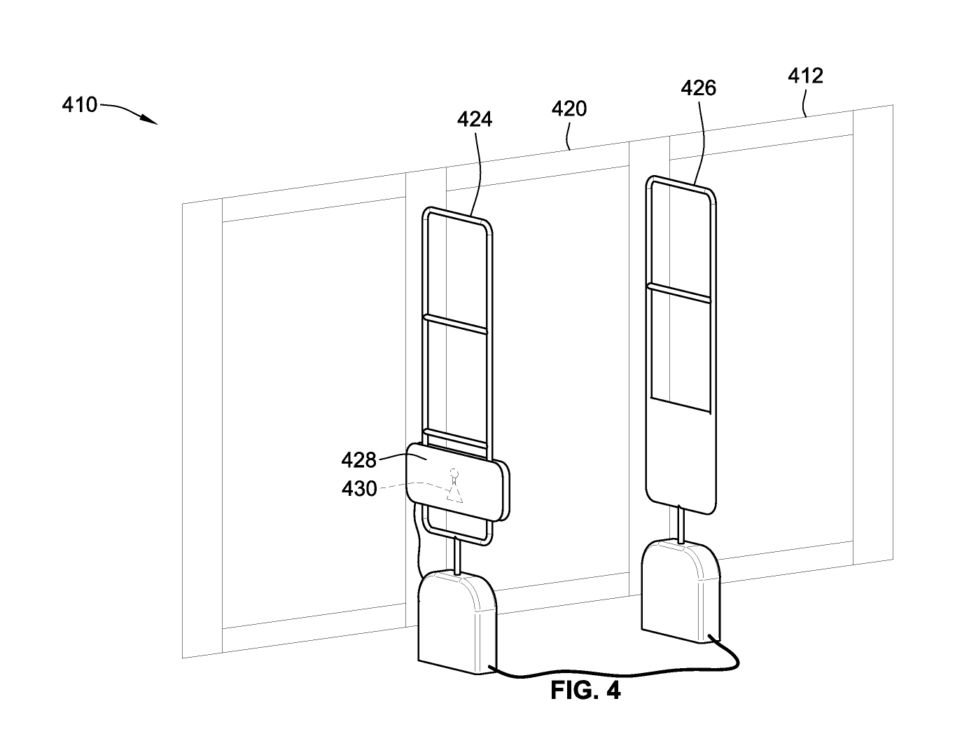

FIG. 4 represents yet another embodiment of the present invention wherein an EAS 422 is fitted with a CPIA 428. Here the CPIA 428 is not a stand-alone assembly. Instead CPIA 428 is embedded and supported by antenna frame 424. The EAS 422 is comprised of two antenna frames 424, 426 comprising a transmitter 424 and receiver 426 in opposed space relation near an exit door 420 of a retail store 412. The CPIA 428 is embedded within antenna frame 424. Furthermore, the CPIA 428 in this embodiment is comprised of a transceiver 430 communicatively coupled to the EAS 422, the controller 434. CPIA 428 may be comprised of only a receiver within the antenna frame 424. In still other embodiments CPIA 428 may be embedded in the second frame 426 and in still other embodiments the CPIA 428 may be embedded in both frames 424 and 426. As with every embodiment heretofore discussed, if a retail store is not equipped with a preexisting EAS 422 then installation of the security system 10, 210, 310, 410 would be installed as an entirely new security system, depending on the needs of the retail store, as illustrated and described for example in the embodiments of security systems 10, 210, 310 and 410.

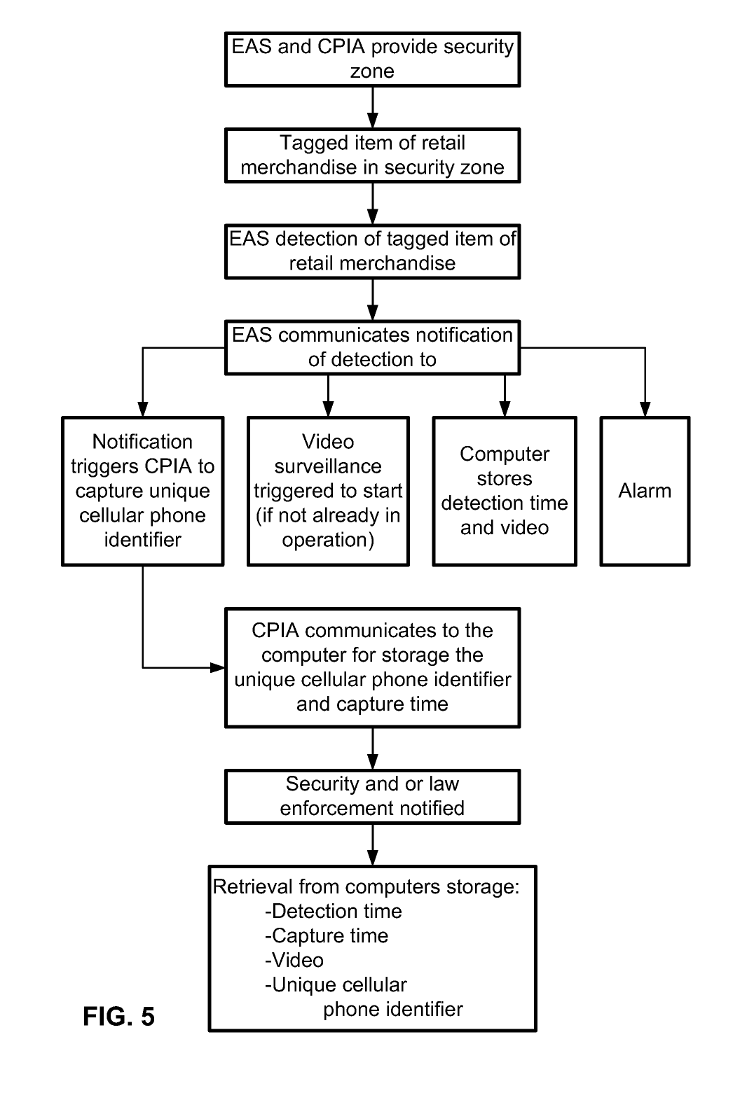

FIG. 5 represents in block diagram the method steps involved in an embodiment of the present invention as discussed in FIG. 1.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A security system, comprising
an electronic article surveillance assembly (EAS);
a cellular phone identification assembly communicatively coupled to the electronic surveillance assembly;
a computer communicatively coupled to the assemblies;
wherein the assemblies define a security zone; and
wherein upon detection of a tagged item of retail merchandise by the EAS, the cellular phone identification assembly captures an at least one unique cellular phone identifier for storage within a storage device of the computer.

2. The security system of claim 1, wherein the EAS is at least one of a radio frequency (RF) system, a radio frequency identification system (RFID), or an acoustic magnetic (AM) system.

3. The security system of claim 2, wherein the EAS further comprises a transmitter in an antenna frame in opposed space relation to a receiver in a second antennae frame of the EAS and the cellular phone identification assembly is a stand-alone assembly.

4. The security system of claim 3, wherein the cellular phone identification assembly is located within one of the first or second antennae frames.

5. The security system of claim 2, wherein the EAS further comprises a transmitter and receiver in a same antennae frame.

6. The security system of claim 5, wherein the cellular phone identification assembly is a stand-alone assembly.

7. The security system of claim 5, wherein the cellular phone identification assembly is located within the same antennae frame.

8. The security system of claim 2, wherein the cellular phone identification assembly is comprised of at least one stand-alone transceiver for active and passive detection of the at least one unique cellular phone identifier.

9. The security system of claim 2, wherein the captured at least one unique cellular phone identifier is one of a Bluetooth identifier, a WiFi media access control (MAC) address, a Near Field Communication (NFC) identifier, and Wireless Communication Network (WCN) identifier.

10. The security system of claim 1, further comprising a video surveillance system communicatively coupled to the assemblies and the computer.

11. A method for capturing a unique cellular phone identifier of a suspected retail thief, the method comprising:
detecting a tagged item of retail merchandise carried by the suspected retail thief within a security zone;
communicating the detection to a cellular phone identification assembly located within the security zone and to an alarm system;
capturing an at least one unique identifier of a cellular phone of the suspected retail thief by the cellular phone identification assembly;
storing for later retrieval and analysis in a computer, a detection time, the at least one unique cellular phone identifier and a capture time of the at least one unique cellular phone identifier.

12. The method of claim 11, wherein the security zone is provided by an electronic article surveillance assembly (EAS) and a cellular phone identification assembly communicatively coupled to the EAS.

13. The method of claim 12, wherein the EAS is at least one of a radio frequency (RF) system, a radio frequency identification system (RFID), or an acoustic magnetic (AM) system.

14. The method of claim 13, wherein the cellular phone identification assembly is comprised of a transceiver and a receiver.

15. The method of claim 14, wherein the security zone is located both inside and outside of a retail store.

16. The method of claim 12, wherein the step of providing the security zone include installing and communicatively coupling the cellular phone identification assembly in a pre-existing EAS within a retail store.

17. The method of claim 12, wherein the step of providing the security zone includes providing a stand-alone cellular phone identification assembly that is communicatively coupled to a pre-existing EAS within a retail store.

18. The method of claim 11, wherein the capturing of the at least one unique identifier is at least one of a blue tooth identifier, a WiFi media access control (MAC) address, a Near Field Communication (NFC) identifier, and Wireless Communication Network (WCN) identifier.

19. The method of claim 11, further comprising the step of notifying a jurisdictional law enforcement agency and retrieving from the computer storage, the transmission time, the at least one unique cellular phone identifier and the capture time of the at least one unique cellular phone identifier.

20. A method for capturing a unique cellular phone identifier of a retail thief, the method comprising:
providing a security zone;
the security zone including:
an electronic article surveillance assembly (EAS);
a cellular phone identification assembly;
communicatively coupling the assemblies;
communicatively coupling the assemblies to a computer;
detecting a tagged item of retail merchandise by the EAS as the retail merchandise passes through the security zone;
communicating a notification of the detection to the computer and to the cellular phone identification assembly;
capturing an at least one of a unique cellular phone identifier by the cellular phone identification assembly;
communicating the capture of the at least one unique cellular phone identifier to the computer;
storing for later retrieval by the computer a detection time, the at least one unique cellular phone identifier and a time of capture of the at least one of a unique cellular phone identifier;
communicating the detection time, the at least one unique cellular phone identifier and the time of capture to law enforcement personnel.

21. The method of claim 20, wherein prior to the step of communicating a notification of the transmission to the computer, the notification is sent to a controller for further notification to the cellular phone identification assembly.

22. The method of claim 21, wherein the notification to the cellular phone identification assembly triggers the cellular phone identification assembly to capture the at least one unique cellular phone identifier.

23. The method of claim 22, wherein the cellular phone identification assembly is located inside a retail store and outside the retail store.

24. The method of claim 23, wherein the cellular phone identification assembly is comprised of at least one transceiver.

25. The method of claim 20, wherein the EAS is at least one of a radio frequency (RF) system, a radio frequency identification system (RFID), or an acoustic magnetic (AM) system.

26. The method of claim 20, wherein the at least at least one unique identifier is at least one of a Bluetooth identifier, a WiFi media access control (MAC) address, a Near Field Communication (NFC) identifier, and Wireless Communication Network (WCN) identifier.
